(19) United States
(12) Patent Application Publication
(10) Pub. No.: US 2012/0122361 A1
(43) Pub. Date: May 17, 2012

(54) Treatment of Textile Materials

(75) Inventors: Geoffrey Hand, West Midlands (GB); Robert Hicklin, Leicestershire (GB); Tim Smith, West Midlands (GB)

(73) Assignee: Rhodia Operations, Aubervilliers (FR)

(21) Appl. No.: 13/322,428

(22) PCT Filed: Mar. 30, 2010
(86) PCT No.: PCT/EP2010/054154

§ 371 Date: Jan. 18, 2012

(30) Foreign Application Priority Data
May 27, 2009 (GB) 0909040.8

(51) Int. Cl. B32B 5/02; B05D 3/00; B05D 3/10; B05D 5/00; B05D 3/02

(52) U.S. Cl. 442/79; 427/209

(57) ABSTRACT

The invention provides a method for the treatment of textile material having a threat face and a rear face, so as to obtain a treated material that is flame retardant but also provides protection from molten metal splash on the threat face, the method comprising: a) providing a textile material that comprises cotton and/or wool, and that has a weight of 250g/m² or more; b) coating the threat face of the material with water repellent; c) applying a flame retardant treatment, comprising a precursor of a flame retardant agent, to at least the rear face of the material; and d) carrying out a fixing process that generates the flame retardant agent in situ and fixes it to the textile material. Also provided is a treated textile material, the textile material having a threat face and a rear face, wherein the textile material comprises cotton and/or wool, and has a weight of 250g/m² or more, and wherein the rear face of the material has flame retardant agent fixed thereto but the surface of the threat face does not and wherein the threat face of the material is partially or fully coated with water repellent, and an item of protective clothing produced from such material. The material or protective clothing can be used to protect a person from molten metal splash.

The present invention relates to a method of treating textile materials, in particular a method of treating textile materials such that they have flame retardant properties but also offer protection from molten metal splash.

It is known in the art to treat textile materials to impart flame retardant properties. The treated materials may be used in various end applications, including protective clothing.

A known process for the flame-retardant treatment of textile materials consists of impregnation of the material with an aqueous solution of a poly(hydroxyorgano) phosphonium compound. This compound may be a salt, for example a tetrakis(hydroxyorgano) phosphonium salt. Alternatively, the compound may be a condensate, for example a condensate of a tetrakis (hydroxyorgano) phosphonium salt with a nitrogen-containing compound such as urea. Following impregnation, the material is dried and then cured with ammonia to produce a cured, water-insoluble polymer which is mechanically fixed within the fibres of the material. After curing, the polymer is oxidised to convert trivalent phosphorus to pentavalent phosphorus and the material is washed and dried.

There are some applications for protective clothing, including protective clothing for workers in the aluminium industry, where the textile materials used are desired to provide metal splash protection, such that if the wearer is splashed with molten metal he is not burned or otherwise harmed. The industry standard ASTM F955, is used to evaluate the heat transfer through materials for protective clothing upon contact with molten substances, whilst BS EN 373 is used to assess resistance of materials for protective clothing to molten metal splash.

However, to date, there remains a need for a material, which can be used for protective clothing, which is both flame retardant and presents good protection against molten metal splash.

In particular, there is a need for a material which is both flame retardant and presents good protection against molten metal splash for lightweight reactive metals such as aluminium, lithium, magnesium, beryllium, aluminium, zinc and titanium, and alloys based on such metals.

The article “Industry Efforts to Identify FR Fabrics for Molten Aluminium Environments”, Johnson, Charles D. Jr, Light Metals: (New York), 2003, 705-708, discusses testing that has been carried out to try and identify suitable materials.

In a first aspect, the invention provides a method for the treatment of textile material having a threat face and a rear face, so as to obtain a treated material that is flame retardant but also provides protection from molten metal splash on the threat face, the method comprising:
a) providing a textile material that comprises cotton and/or wool, and that has a weight of 250 g/m² or more;
b) coating the threat face of the material with water repellent;
c) applying a flame retardant treatment, comprising a precursor of a flame retardant agent, to at least the rear face of the material; and
d) carrying out a fixing process that generates the flame retardant agent in situ and fixes it to the textile material.

Surprisingly, it has been found that the application of a water repellent to the threat face of the material ensures that this face retains the natural molten metal resistant characteristics of cotton and wool based fabrics, yet does not unduly hinder the uptake of the flame retardant treatment. Therefore a textile material can be obtained that has good flame retardant properties, whilst having a threat face, which can be used as the outer face of protective clothing, that gives good resistance to molten metal splash.

It had not, until now, been appreciated that it might be possible to achieve good flame resistant characteristics without treating the entire material and in particular without directly applying the flame retardant treatment directly to the threat face. However, it has been identified by the inventors that it is in fact possible to confer flame retardancy on the material despite the flame retardant treatment not directly contacting the outer threat face of the material. This therefore permits the good molten metal splash resistance of cotton, wool, and similar materials to be retained for the threat face of the material, which face can be used as the outer surface of a protective clothing product.

The textile material provided in step (a) may comprise cotton, wool, or both. Preferable, the textile material comprises 40 wt % or more cotton and/or wool, preferably 50 wt % or more, such as 60 wt % or more; more preferably 65 wt % or more, e.g. 70 wt % or more, 80 wt % or more or 90 wt % or more.

The textile material used may, in one embodiment, comprise substantially 100% cotton.

Alternatively, the textile material may be a blend of cotton and other fibres. The other fibres may be, for example, cellulosic fibres such as linen, jute, hessian or regenerated cellulosic material; natural non cellulosic fibres such as wool or silk fibres; or synthetic fibres, such as polyester, polyamide, acrylic or aramid fibres. In such a blend, preferably there is 40 wt % or more cotton, preferably 50 wt % or more, such as 60 wt % or more; more preferably 65 wt % or more, e.g. 70 wt % or more, 80 wt % or more or 90 wt % or more.

The textile material may, in another embodiment, comprise substantially 100% wool.

Alternatively, the textile material may be a blend of wool and other fibres. The other fibres may be, for example, cellulosic fibres such as cotton, linen, jute, hessian or regenerated cellulosic material; natural non cellulosic fibres such as silk fibres; or synthetic fibres, such as polyester, polyamide, acrylic or aramid fibres. In such a blend, preferably there is 40 wt % or more wool, preferably 50 wt % or more, such as 60 wt % or more; more preferably 65 wt % or more, e.g. 70 wt % or more, 80 wt % or more or 90 wt % or more.

In a preferred embodiment, the textile material comprises 40 wt % or more cotton, preferably 50 wt % or more, such as 60 wt % or more; more preferably 65 wt % or more. It may be that the material comprises 70 wt % or more cotton, e.g. 80 wt % or more or 90 wt % or more.

In one embodiment, the textile material is a blend comprising cotton fibres and synthetic fibres, e.g. polyester fibres, such as a blend comprising 60 wt % or more cotton together with a synthetic fibre (e.g. polyester) or 65 wt % or more cotton together with a synthetic fibre (e.g. polyester). For example, a blend of 60 wt % cotton fibres and 40 wt % polyester fibres or a blend of 65 wt % cotton fibres and 35 wt % polyester fibres may be considered.

When blended fabrics are used, these may be of any of various types known in the art that allow the use of multiple fibre types in a fabric. In particular, they may be intimate blends, where the different fibres are spun together, or they may be union blends, where different fibres are used in the warp and the weft of the fabric.

The textile material has a weight of 250 g/m² or more, e.g. from 260 to 1000 g/m², preferably 300 g/m² or more, such as from 300 to 800 g/m², for example from 300 to 700 g/m². For use as material for protective clothing the material should not be too lightweight. The use of a weight of 250 g/m² or more also ensures that there is enough weight of fabric for receiving the flame retardant treatment.

Preferably the textile material has no surface treatment prior to the application of the water repellent in step (b). However, a surface treatment may be considered if this is not detrimental to the molten metal splash resistance of the threat face of the material and the material's ability to receive a flame retardant treatment.

The water repellent used in step (b) may be any hydrophobic product that can be applied to a textile material to permit the material to withstand wetting.

As the skilled man would understand, a material is made water repellent by depositing on the fibres a hydrophobic substance; thus water repellent materials have open pores and are permeable to air and water vapour. Therefore within the invention any hydrophobic material that can be applied to the fibres of the textile material on the threat face may be used as the water repellent.

However, within the context of the invention the water repellent could in fact be used to water proof the material. A waterproofed material has its pores filled with a substance impermeable to water. Thus, it will be appreciated that a water repellent could be used which is a hydrophobic substance that is impermeable to water and that if this was used to fill the pores of the material on the threat face then the material would be water proofed.

Examples of water repellents that may be used are:
i) aluminium and zirconium soaps
ii) waxes, e.g. zirconium wax complexes
iii) pyridinium compounds, e.g. stearamidomethylpyridinium chloride
iv) methylol compounds, e.g. N-methylol stearamide
v) polysiloxanes, e.g. poly(dimethylsiloxane)
vi) fluorochemical compounds, both monomeric and polymeric.

In the present invention it can be that the water repellent is removed from the material once the flame retardant has been fixed, either through an immediate washing/treatment to remove some or all of the water repellent, or through use/washing over time.

Thus, in one embodiment, the method further comprises a step of:
(e) washing the textile material to remove some or all of the water repellent from the threat face.

Alternatively, a water repellent can be selected that reacts with the fibre, or self reacts, to give some degree of permanence and resistance to washing. In other words, it may be intended to keep the water repellent on the threat face of the textile material. Fixing agents, such as melamine resins, may be applied with the water repellent to improve fixation/durability in such embodiments.

It will of course be appreciated that the water repellent should be removed from the material once the flame retardant has been fixed in the event that the water repellent has properties that are potentially detrimental to the flame retardancy of the material. However, for example, zirconium wax complexes are known for use in flame retardancy applications and therefore such water repellents need not be removed.

The water repellent may suitably be applied to the material in the form of a water repellent treatment that comprises the water repellent and a carrier.

The carrier may, for example, be one that readily evaporates, leaving the water repellent on the material. In one embodiment, the carrier comprises water and the water repellent is provided as an aqueous dispersion. In another embodiment the carrier comprises an organic solvent.

In one embodiment, the water repellent is provided in the form of a water repellent treatment which is a foam or a paste.

In the event that the water repellent is applied as a foam, a surfactant will be used to generate the foam. The skilled man will appreciate that the surfactant used to generate the foam should be a non rewetting surfactant, such as an amine oxide surfactant or a fluorinated surfactant. Examples include MYKON NRW-3 and SULFANOLE 270 (available from Omnova Solutions Inc).

In the present invention, the amount of water repellent applied is preferably enough to make the textile material water repellent on the threat face, to which the water repellent is applied. This can be tested by placing drops of water on the face in question, and then on the reverse face, to demonstrate that the hydrophobic substance applied is only repelling water on the face side.

In one embodiment, the water repellent is applied to the material such that a dry solids weight gain on the material of 0.05% or more, e.g. 0.1% or more, is achieved, such as from 0.1 to 10 wt %, or from 0.1 to 5 wt %, e.g. from 0.1 to 1 wt %. Preferably, a dry solids weight gain on the material of 0.2% or more is achieved, for example from 0.2 to 10 wt %, such as from 0.2 to 5 wt %, or from 0.2 to 1 wt %, e.g. from 0.2 to 0.5%.

The water repellent may be applied to the face of the material in step (b) using any suitable technique. Techniques that may be envisaged include:
spray application,
knife application (e.g. knife over roller application or knife over air application),
lick roller application,
screen coating (e.g. rotary screen or flat screen coating), and
plasma treatment.

These techniques are known in the art. The book “Handbook of technical textiles” by A Horrocks and S C Anand, Textile Institute, published by Woodhead Publishing, 2000 describes in Chapter 8 various coating techniques for textiles, including knife coating, lick roller coating and screen coating. Plasma treatment of materials is described in, for example, Pure Appl. Chem., 2002, Vol. 74, No. 3, pp 423-427.

The water repellent may be applied together with a viscosifier which acts to increase the viscosity of the water repellent and therefore improve the ease of application of the water repellent. The viscosifier may suitably be mixed with the water repellent prior to application.

Examples of viscosifiers include: hydroxy ethyl cellulose, alginate, starch derivatives, flour, tamarind, sodium alginate, dextrine, albumen, sodium polyacrylate, and gum based products such as gum arabic, guar gum derivatives, gum Senegal, gum tragacanth, and British gum.

Clearly the viscosity of the water repellent can be modified by addition of suitable amounts and types of viscosifiers, bearing in mind the chosen application technique.

Equally, the form in which the water repellent is provided may be selected bearing in mind the chosen application technique. For example, if the water repellent is to be applied using a spray treatment then a liquid, foam or dispersion could be suitable but a paste would not be.

The use of the water repellent in the form of a treatment that is a foam or a paste may improve the ease of application of the water repellent.

The precursor of a flame retardant agent used in step (c) may be any product that can be applied to materials to generate flame retardant properties.

Known flame retardant treatments include:
inorganic flame retardants; e.g. aluminium trihydroxide, magnesium hydroxide, antimony trioxide, ammonium bromide, hydrates, including aluminium hydrate, and boron-based compounds, including boric acid and borates;
halogenated organic flame retardant compounds, in particular:—
   chlorinated flame retardants; e.g organochlorines (such as polychlorinated biphenyls), chlorendic acid derivates (such as dibutyl chlorendate and dimethyl chlorendate), chlorinated paraffins,
   brominated flame retardants; e.g. polybrominated diphenyl ethers, polybrominated biphenyl, and brominated cyclohydrocarbons;
organophosphorus compounds, in particular:—
   organophosphate flame retardants; which may be halogenated or non halogenated, (such as tri-alkyl or tri-aryl phosphates, di- and tri-bromoalkyl phosphates and di- and tri-chloroalkyl phosphates; for example tri-o-cresyl phosphate, tris(2,3-dibromopropyl) phosphate, bis(2,3-dibromopropyl) phosphate);
   organophosphite flame retardants, such as dialkyl phosphites;
   phosphine oxide flame retardants, particularly those of the N-methylol propionamide class, such as N-methylol-3-(dimethylphosphinyl)propionamide and N-methylol-3-(dimethyl phosphono)propionamide
   poly(hydroxyorgano) phosphonium compounds;
nitrogen compounds; e.g. melamine compounds.

In view of the intended application of the treated textile in protective clothing, flame retardants with good durability are preferred. For example, organophosphorus compounds may be preferred.

In view of environmental concerns, it is preferred that the precursor to the flame retardant agent does not include heavy metals, e.g. antimony, or boron.

In one embodiment, the precursor of the flame retardant agent is an organophosphorus compound, such as a poly(hydroxyorgano) phosphonium compound, a phosphine oxide compound, an organophosphite compound or an organophosphate compound.

When the precursor of a flame retardant agent is a poly(hydroxyorgano) phosphonium compound, it may suitably be a tetra(hydroxyorgano) phosphonium compound.

In the poly(hydroxyorgano) phosphonium compound, each hydroxyorgano group is preferably an alpha hydroxyorgano group of 1-9 carbons, especially one of formula:

HOC—(R1R2)—

wherein each of R1 and R2, which may be the same or different, represents hydrogen or an alkyl group of 1 to 4 carbons e.g. methyl or ethyl. Preferably R1 is hydrogen and in one embodiment both R1 and R2 are hydrogen, as in tetrakis(hydroxymethyl) phosphonium (THP) compounds.

The poly(hydroxyorgano) phosphonium compound may in one preferred embodiment be a tetrakis(hydroxyalkyl) phosphonium salt.

Alternatively, in another preferred embodiment the poly(hydroxyorgano) phosphonium compound may be a condensate of a tetrakis(hydroxyalkyl) phosphonium salt with a nitrogen-containing compound.

Preferably, the method uses a THP salt or a THP condensate.

In principal, any water soluble THP salt with an anion which does not interact adversely with other components present may be used. Preferably, a tetrakis(hydroxymethyl)phosphonium salt of formula THPX, wherein X is chloride, sulphate, bromide, iodide, phosphate, acetate, oxalate, citrate, borate, chlorate, lactate, nitrate, fluoride, carbonate or formate, is used. In particular, THPC and THPS may be mentioned.

THP condensates are water soluble or sparingly water soluble copolymers of THP with organic nitrogen compounds, such as urea or an amine. In one embodiment, the condensate is a copolymer of THP with urea, a C1-C20 alkylamine, dicyandiamide, thiourea or guanidine. The molar ratio of THP to nitrogen compound may be, for example, 2:1 or higher, such as 3:1 or higher, preferably 4:1 or higher, such as 5:1 or higher, for instance from 5:1 to 7:1 molar THP:nitrogen compound.

THP condensates may contain two or more phosphorus atoms, so long as the phosphorus compound is water soluble to a concentration of at least 0.5 g/l at 25° C. Such phosphorus compounds contain a total of at least two hydroxymethyl groups, usually at least one per phosphorus atom, and preferably at least two hydroxymethyl groups per phosphorus atom. In the THP condensate the group or groups joining the phosphorus atoms together may be of the formula —R—, —R—O—, —R—O—R—, —R—NH—R or —R—R″—R where R is an alkylene group of 1 to 4 carbon atoms and R″ is the residue formed by removal of two hydrogen atoms, bonded to nitrogen, from a di or polyamide or an amine or di or polyamine, such as urea, a C1-C20 alkylamine, dicyandiamide, thiourea or guanidine. Such compounds with two or more, e.g. three, hydroxyalkyl groups per phosphorus atom may be made by self condensation of THP salts with a compound of general formula R″H₂ such as urea, or a C1-C20 alkylamine, e.g. by heating at 40 to 120° C.

Examples of suitable products include PERFORM CC™ and PERFORM STi™ (available from Rhodia Novecare).

The skilled man would readily be able to select appropriate amounts of flame retardant precursor (e.g. poly(hydroxyorgano) phosphonium compound) based on the textile fabric to be treated (in particular its density) and its intended end use (in particular the standard and durability criteria the treated fabric will need to meet).

The amount of flame retardant precursor (e.g. poly(hydroxyorgano) phosphonium compound) used will usually be calculated so as to give a 5 to 50% add on, based on the active ion/solids, such as from 10 to 40% or from 10 to 30%. The skilled man will of course understand that a suitable add on should be selected in view of the flame retardant selected; for example the values needed for phosphonamide type flame retardants would generally be lower than those for poly(hydroxyorgano) phosphonium type flame retardants.

This will require an appropriate concentration in the treatment solution to be applied to the textile material, based on the pick up rate. For example, a 40% add on would be achieved by use of a 50% solution with an 80% pick up rate.

The amount of flame retardant precursor (e.g. poly(hydroxyorgano) phosphonium compound) used in the treatment in step (c) may, for example, be from 5 to 50% (expressed by weight of active ion).

If desired, the flame retardant treatment used in step (c) may contain a wetting agent, e.g. a nonionic or anionic wetting agent.

The flame retardant treatment used in step (c) may be applied only to the rear face of the textile material. Alternatively, the flame retardant treatment may be applied to some or all of the threat face of the material.

In the event that the flame retardant treatment used in step (c) is applied to some or all of the threat face of the material, it is particularly important to ensure the complete coverage of the threat face with the water repellent in step (b), to avoid any degree of contamination of the threat surface. It will be appreciated that the flame retardant treatment is applied to both faces purely for ease of application; the flame retardant treatment will be prevented from contacting the threat face by the water repellent coating.

In one embodiment, the flame retardant treatment used in step (c) may be applied using spray application. This may be used to apply the treatment to the rear face only.

In another embodiment, the flame retardant treatment used in step (c) may be applied using a full dip impregnation or using a mangle. This may be used to apply the treatment to the rear face and threat face.

The flame retardant treatment may be used in any suitable form, bearing in mind the method of application chosen. For example, a solution or foam may be used.

In one embodiment, the flame retardant treatment is applied as an aqueous solution. In another embodiment, the flame retardant treatment is applied as a water based foam.

In the event that the flame retardant treatment is applied as a foam, a surfactant will be used to generate the foam. The skilled man will appreciate that the surfactant used to generate the foam should be a non rewetting surfactant, such as an amine oxide surfactant or a fluorinated surfactant. Examples include MYKON NRW-3 and SULFANOLE 270 (available from Omnova Solutions Inc).

The fixing process carried out in step (d) will be selected in view of the flame retardant chosen. It is known in the art how to generate and fix a given flame retardant to a material. This step may, for example, involve a heat cure or a chemical cure. It may also involve a step of oxidation.

In one embodiment, the precursor of the flame retardant agent is a poly (hydroxyorgano) phosphonium compound, and step (d) involves ammonia curing followed by oxidation.

Optionally, a wash off step is carried out after step (d).

Optionally, a drying step is carried out after step (d).

Thus, in one embodiment, the method further comprises:
(e) optionally washing the textile material;
(f) optionally drying the textile material.

The invention also provides, in a second aspect, a treated textile material obtainable by the method of the first aspect.

The invention also provides, in a third aspect, a treated textile material, the textile material having a threat face and a rear face, wherein the textile material comprises cotton and/or wool, and has a weight of 250 g/m² or more, and wherein the rear face of the material has flame retardant agent fixed thereto but the surface of the threat face does not.

The material of the second and third aspects is flame retardant but also provides protection from molten metal splash on the threat face.

The threat face may be partially or fully coated with any substance that is not flame retardant agent or any other substance that would cause molten metal to stick.

In one embodiment, the threat face of the material is partially or fully coated with water repellent. The water repellent is as defined above.

In another embodiment, the threat face of the material does not have a coating.

The preferred details of the textile material and flame retardant are as defined above.

The invention also provides, in a fourth aspect, an item of protective clothing produced from the material of the second aspect or the third aspect.

Clearly, it is intended that the threat face of the material is on the outside of the clothing when worn.

The protective clothing may, for example, be a coat, trousers, a hat, an apron, a top, a shirt, or gloves.

The invention also provides, in a fifth aspect, the use of a material in accordance with the second or third aspect or protective clothing in accordance with the fourth aspect to protect a person from molten metal splash.

The molten metal may be any metal but in particular may be a lightweight reactive metal such as alkali metals (e.g. lithium), alkaline earth metals (e.g. magnesium, beryllium), aluminium, zinc and titanium. It may also be an alloy, for example an alloy based on a lightweight reactive metal. In one embodiment, the metal is aluminium.

The invention will be described further in the following, non limiting, examples.

### EXAMPLES

### Test Used for Assessing Molten Metal Splash Resistance

The basis for the test is BS EN 373, where 100 grams of molten Al is poured on to a fabric mounted on top of a PVC skin simulant. The fabric and PVC are held on a pin frame at an angle of 60° to the horizontal. The metal is poured on to the surface of the fabric from a height of 225 mm. The PVC is assessed for damage; the extent of damage gives an indication of the protection expected when a fabric is exposed to a similar threat.

The main criterion to be observed is the material's metal shedding ability.

### Equipment

The following equipment is used:
Pouring apparatus and fabric support frame.
Electrically heated muffle furnace.
Carbon crucibles.
Crucible holder
Sand.
Two sets of PPE suitable to give protection against aluminium metal splash.
Template

### Test Procedure

### 1. Sample Conditioning

Sample should be conditioned for at least 24 hours in an atmosphere having a temperature of 20+/−2° C. and a relative humidity of 65%+/−2%. Samples should be brought to the test area from the conditioning room in desiccating containers. Samples should be tested within 2 minutes of removal from the container.

### 2. Sample Preparation

For initial laboratory trials two samples from the warp and two samples from the weft direction will be used.

### 3. Setting Up Pouring Apparatus

The pouring device should be set up to give the correct specified height of pour. This is the distance between the centre of the drive shaft to the centre of the pin frame. The pin frame should be adjusted to the specified angle.

### 4. Molten Metal Preparation

20 grams of aluminium is weighed out for each pouring. After weighing, the aluminium is transferred to the crucible and placed in the oven set at a temperature of 820° C. for melting.

### 5. Attachment of Test Material to Pin Frame

The test specimen is attached to the pin frame, taking care to ensure the fabric is free of creases and that the envisaged “threat side” of the fabric is face up.

### 6. Pouring of Molten Metal

The crucible is transferred to the pouring device using the crucible holder; then the pouring device is operated, allowing molten metal to be poured on to the test specimen.

### 7. Examination

It is noted whether molten aluminium has adhered to the fabric surface.

I—Comparison of Untreated Fabric with Fabric Having Flame Retardant Treatment

A number of samples of untreated fabric were tested using the molten metal splash test. Samples of fabric fully treated with flame retardant (in accordance with normal manufacturer's guidelines) were also tested. The results are shown in Table 1.

TABLE 1

| | | | | | | Metal | |
|---|---|---|---|---|---|---|---|
| | | | | | Weight | sticks to | |
| | Fabric | Weight | | Fibre | of pour | textile | |
| | construction | (g/m²) | Finish | Composition | (grams) | (Y/N) | Observations |
| 1 | Woven satin | 307 | Untreated | Cotton | 10 | N | Instantaneous |
| | | | | | | | run off |
| 2 | Woven satin | 355 | PERFORM | Cotton | 10 | Y | Sticks |
| | | | CC | | | | instantly |
| 3 | Woven satin | 355 | PERFORM | Cotton | 10 | Y | Sticks |
| | | | STi | | | | instantly |
| 4 | Woven satin | 307 | Untreated | Cotton | 20 | N | Instantaneous |
| | | | | | | | run off |
| 5 | Woven satin | 355 | PERFORM | Cotton | 20 | Y | Sticks |
| | | | CC | | | | instantly |
| 6 | Twill dyed | 300 | Untreated | 65 wt % | 20 | N | Instantaneous |
| | workwear | | | Cotton | | | run off |
| | fabric | | | 35 wt % | | | |
| | | | | Polyester | | | |
| | | | | (intimate | | | |
| | | | | blend) | | | |
| 7 | Woven satin | 355 | PERFORM | Cotton | 20 | Y | Sticks |
| | | | STi | | | | instantly |

It can be seen that the untreated cotton based material is resistant to molten metal splash but that the flame retardant treatment adversely affects the ability of the material to resist molten metal splash. Although the tested flame retardants are phosphorus based flame retardants of the poly(hydroxyorgano) phosphonium type, it is known within the art that materials treated with other flame retardants are also not viewed as suitable for use in metal splash situations.

II—Comparison of Fabric Having Standard Flame Retardant Treatment with Treatment in Accordance with the Invention

A number of samples of fabric were treated with flame retardant. These were either: fully treated with flame retardant (in accordance with normal manufacturer's guidelines); treated in accordance with the invention (i.e. water repellent coating applied to one face prior to flame retardant treatment); or coated with a NanoSphere® coating (from Schoeller Technologies AG; distributed by Clariant International Limited) after the flame retardant treatment. The effect of fabric nipping, and of washing after the flame retardant treatments (but before the molten splash test), was also assessed.

The two water repellents used in the tests were spray can fluorochemical type water repellent products.

The face 1 is the face that would be used as the outer surface in protective clothing, i.e. it is the “threat side”. This must be able to meet the molten metal splash requirements and is the side tested as described above.

The results are shown in Table 2.

TABLE 2

| | | | |
|---|---|---|---|
| | Weight of | METAL | |
| | pour | STICKS | |
| TREATMENT | (Grams) | Y/N | Observations |

COTTON SATIN WORKWEAR 480GSM FABRIC

| | | | | |
|---|---|---|---|---|
| A | PERFORM CC treatment of entire fabric | 10 | Y | Metal sticks to face 1 |
| B | As A but also washed | 10 | Y | Metal sticks to face 1 |
| C | Water repellent spray treatment of face 1; | 10 | N | Metal shed from face 1 |
| | PERFORM CC spray treatment of face 2 | | | |
| D | As C but also washed | 10 | N | Metal shed from face 1 |
| E | Water repellent spray treatment of face 1; | 10 | N | Metal shed from face 1 (small |
| | PERFORM CC spray treatment of face 2; | | | degree of sticking on pins of pin |
| | followed by nipping of fabric | | | frame) |
| F | As E but also washed | 10 | N | Metal shed from face 1 (small |
| | | | | degree of sticking on pins of pin |
| | | | | frame) |
| G | Water repellent spray treatment of face 1; | 20 | Y | Some contamination was noted |
| | PERFORM CC dip treatment of full fabric | | | on fabric face |
| | | | | Metal sticks to face 1 |
| H | As G but less contamination on fabric face | 20 | N | Metal mostly shed from face 1 |
| | | | | (some partial sticking) |
| I | Repeat of E using different water repellent | 20 | N | Metal shed from face 1 |
| J | PERFORM CC dip treatment of entire fabric; | 10 | Y | Metal sticks |
| | followed by a NANOSPHERE ® coating | | | |
| K | As J but also washed | 10 | Y | Metal sticks |

COTTON TWILL WORKWEAR 350GSM FABRIC

| | | | | |
|---|---|---|---|---|
| L | PERFORM CC dip treatment of entire fabric; | 10 | Y | Metal sticks |
| | followed by a NANOSPHERE ® coating | | | |
| M | As L but also washed | 10 | Y | Metal sticks |

It can be seen that the products treated in accordance with the invention have resistance to molten metal splash. In contrast, products that were fully treated with flame retardant without any prior water repellent treatment did not have resistance to molten metal splash. This was the case even when a coating was subsequently applied over the flame retardant treated material.

### III—Assessment of Flame Redardancy Properties for Samples Prepared According to the Invention

Samples having had (i) water repellent spray treatment of face 1 and PERFORM CC spray treatment of face 2 (as test C) and (ii) water repellent spray treatment of face 1; PERFORM CC spray treatment of face 2; followed by nipping of fabric (as test E) were tested for flame retardancy.

The test was carried out relation to face 1 (the “threat side”) in accordance with BS EN533.

Samples (i) and (ii) were tested: (1) after the flame retardant treatment was applied; and (2) after being subjected to 50 washes subsequent to the flame retardant treatment.

All samples passed the flame retardancy test.

Accordingly, it was determined that even though face 1 had not been directly exposed to the flame retardant from its outer surface, due to the water repellent coating being present, it had been imparted with sufficient flame retardant properties.

The PERFORM flame retardant products referred to in the Examples are available from Rhodia Novecare to PROBAN® licensees.

1-19. (canceled)

20. A method for the treating a textile material comprising a threat face and a rear face, said method comprising:
coating the threat face of the material with a water repellent;
wherein the textile material comprises cotton and/or wool, and weighs 250 g/m² or more;
applying a composition comprising a precursor of a flame retardant agent to at least the rear face of the material; and
generating and fixing the flame retardant agent to the textile material in situ;
wherein the treated material is flame retardant and is adapted to provide protection from molten metal splash on the threat face.

21. The method of claim 20, wherein the textile material comprises 50 wt % or more of cotton, wool, or a combination thereof.

22. The method of claim 21, wherein the textile material comprises 100% cotton or a blend of cotton and other fibers comprising 50 wt % or more of cotton.

23. The method of claim 20, wherein the textile material weighs 300 g/m² or more.

24. The method of claim 20, wherein the water repellent comprises an aluminium or zirconium soap; a wax; a pyridinium compound; a methylol compound; a polysiloxane; a fluorochemical compound, or a combination thereof.

25. The method of claim 20, further comprising removing the water repellent from the material after the flame retardant is fixed.

26. The method of claim 20, wherein the water repellent is applied to the material in an amount wherein a dry solids weight gain of the material ranges from 0.1 to 10 wt %.

27. The method of claim 20, wherein the precursor to the flame retardant agent comprises an organophosphorus flame retardant precursor.

28. The method of claim 27, wherein the precursor of the flame retardant agent comprises a poly(hydroxyorgano)phosphonium compound.

29. The method of claim 28, wherein the poly(hydroxyorgano)phosphonium compound comprises a tetrakis(hydroxyalkyl)phosphonium salt or a condensate of a tetrakis(hydroxyalkyl)phosphonium salt with a nitrogen-containing compound.

30. The method of claim 20, wherein the amount of flame retardant precursor gives a 30 to 50% add on to the textile material.

31. The method of claim 20, wherein the fixing step comprises a curing with heat or a chemical.

32. The method of claim 20, wherein the method further comprises washing the textile material or washing and drying the textile material.

33. A treated textile material comprising a threat face and a rear face, wherein:
the textile material comprises cotton and/or wool;
the textile material has a weight of 250 g/m² or more;
the textile material comprises a flame retardant fixed to the rear face;
the flame retardant is not fixed to the surface of the threat face; and
the threat face of the material is partially or fully coated with water repellent.

34. The textile material of claim 33, wherein the water repellent comprises an aluminium or zirconium soap; a wax; a pyridinium compound; a methylol compound; a polysiloxane; a fluorochemical compound, or a combination thereof.

35. An item of protective clothing made from the material of claim 33.

36. A method of protecting a person from molten metal splash comprising, protecting the person with a treated textile material or a protective clothing that is made from the treated textile material.
wherein:
the treated textile material comprises a threat face and a rear face;
the textile material comprises cotton and/or wool;
the textile, material weighs 250 g/m² or more;
the rear face of the material comprises a flame retardant agent fixed thereto; and
the surface of the threat face does not comprise a flame retardant fixed thereto.

37. The method of claim 36, wherein the molten metal comprises an alkali metal, an alkaline earth metal, aluminium, zinc, titanium, or an alloy comprising a combination thereof.

38. The method of claim 36, wherein the threat face of the material is partially or fully coated with water repellent.

39. The textile material of claim 38, wherein the water repellent comprises an aluminium or zirconium soap; a wax; a pyridinium compound; a methylol compound; a polysiloxane; a fluorochemical compound, or a combination thereof.
